(19) United States
(12) Patent Application Publication
(10) Pub. No.: US 2026/0079688 A1
(43) Pub. Date: Mar. 19, 2026

(54) METHOD AND SYSTEM FOR DECOMMISSIONING OF APPLICATIONS

(71) Applicant: JPMorgan Chase Bank, N.A., New York, NY (US)

(72) Inventors: John PAULSON, McKinney, TX (US); Bhartendu AKHILESH, Dallas, TX (US); Kiran VEDERE, Newark, DE (US)

(73) Assignee: JPMorgan Chase Bank, N.A., New York, NY (US)

(21) Appl. No.: 18/886,719

(22) Filed: Sep. 16, 2024

(51) Int. Cl. G06F 8/61

(52) U.S. Cl. CPC G06F 8/62

(57) ABSTRACT

Various methods and processes, apparatuses or systems, and media for decommissioning of applications, related components, and data are disclosed. The method includes: receiving first information that relates to an application for decommissioning; retrieving second information that relates to components and data sources associated with the application; obtaining third information that relates to data usage associated with the application; identifying an alternate data source associated with a target platform; constructing a physical data model in the alternate data source; migrating a predetermined set of data associated with the application to the alternate data source; obtaining a confirmation for a decommissioning of the application and for an archival of legacy data; performing a lockdown operation and a physical decommissioning of the application, the components, and the data sources; and performing a validation that all traces of the application, the components, and the data sources have been removed as a result thereof.

### TECHNICAL FIELD

This disclosure relates to methods and apparatuses for decommissioning of applications, related components, and data in a consistent and complete manner in order to reduce vulnerabilities, security risks, and regulatory impacts.

### BACKGROUND

The developments described in this section are known to the inventors. However, unless otherwise indicated, it should not be assumed that any of the developments described in this section qualify as prior art merely by virtue of their inclusion in this section, or that these developments are known to a person of ordinary skill in the art.

In many large organizations, modernizing data technology platforms and applications, together with migration of data to target platforms, is a major undertaking. Identification and decommissioning of applications that are either on the path to retirement or have a low level of consumption provides a significant boost towards eliminating a need, effort, and cost of modernizing, migrating, and maintain such applications in the target state.

Conventionally, there has been no standard approach or process for decommissioning of applications, related components, and corresponding data. In addition, there has been a lack of decommissioning completeness criteria, which has resulted in an inconsistent and incomplete end state, thereby leaving behind residual traces of the application, components, data, and access points. This, in turn, has led to system vulnerabilities, security risks, regulatory impacts, and audit-related impacts.

Accordingly, there is a need for a mechanism for decommissioning of applications, related components, and data in a consistent and complete manner in order to reduce vulnerabilities, security risks, and regulatory impacts.

### SUMMARY

The present disclosure, through one or more of its various aspects, embodiments, and/or specific features or sub-components, provides, among other features, various systems, servers, devices, methods, media, programs, and platforms for decommissioning of applications, related components, and data in a consistent and complete manner in order to reduce vulnerabilities, security risks, and regulatory impacts.

According to an aspect of the present disclosure, a method for decommissioning an application is provided. The method may be implemented by at least one processor. The method includes: receiving first information that relates to a first candidate application for a potential decommissioning; retrieving, based on the first information, second information that relates to at least one component and at least one data source associated with the first candidate application; obtaining, based on the first information, third information that relates to data usage associated with the first candidate application; identifying at least one alternate data source that is associated with a target platform to be used for hosting a successor to the first candidate application; constructing, based on the first information, the second information, and the third information, a data model in the at least one alternate data source; migrating a first predetermined set of data associated with the first candidate application to the at least one alternate data source; obtaining a confirmation for each of the potential decommissioning of the first candidate application and an archival of legacy data associated with the first candidate application; performing a lockdown operation with respect to the first candidate application, the at least one component, and the at least one data source; executing a decommissioning of the first candidate application, the at least one component, and the at least one data source; and performing a validation that all traces of the first candidate application, the at least one component, and the at least one data source have been removed as a result of the decommissioning.

The method may further include: after the receiving of the first information and before the retrieving of the second information, analyzing the first information to determine whether to recommend the decommissioning of the first candidate application; and when a determination to recommend the decommissioning of the first candidate application is made, obtaining an approval for the decommissioning of the first candidate application from a predetermined entity.

The identifying of the at least one alternate data source may include validating that the at least one alternate data source is associated with the target platform, performing a data comparison between a current data state and a target data state, performing a data reconciliation based on a result of the data comparison; and confirming that the target data state is acceptable to affected entities.

The constructing of the data model may include implementing at least one data management control requirement that relates to at least one from among a data security requirement, a data access requirement, a data archiving requirement, and a data retention requirement.

The method may further include: after the constructing of the data model and before the migrating of the first predetermined set of data, constructing a set of code that is configured to shift data consumption from the at least one data source associated with the first candidate application to the at least one alternate data source; using the data model to execute a predetermined test of the set of code; and using a result of the predetermined test to confirm that the migrating of the first predetermined set of data is permissible.

The obtaining of the confirmation for each of the potential decommissioning of the first candidate application and the archival of the legacy data may include: ensuring that entities impacted by the decommissioning are aware of the potential decommissioning; and documenting the confirmation.

The entities impacted by the decommissioning may include at least one product/application team associated with the first candidate application and at least one information owner associated with data that relates to the at least one data source.

The performing of the lockdown operation may include: notifying affected entities of the lockdown operation; and validating that all data objects, access points, application processes, and components are successfully locked down.

The method may further include: after the performing of the lockdown operation and before the executing of the decommissioning, executing an archival of a second predetermined set of data to a predetermined platform; applying at least one predetermined retention rule to the second predetermined set of data; and confirming that the archival of the second predetermined set of data and the applying of the retention rule have been successfully completed.

According to another embodiment, a computing apparatus for decommissioning an application is provided. The computing apparatus includes a processor; a memory; and a communication interface coupled to each of the processor and the memory. The processor is configured to: receive, via the communication interface, first information that relates to a first candidate application for potential decommissioning; retrieve, from the memory based on the first information, second information that relates to at least one component and at least one data source associated with the first candidate application; obtain, based on the first information, third information that relates to data usage associated with the first candidate application; identify at least one alternate data source that is associated with a target platform; construct, based on the first information, the second information, and the third information, a data model in the at least one alternate data source; migrate a first predetermined set of data associated with the first candidate application to the at least one alternate data source; obtain a confirmation for each of the potential decommissioning of the first candidate application and an archival of legacy data associated with the first candidate application; perform a lockdown operation with respect to the first candidate application, the at least one component, and the at least one data source; execute a decommissioning of the first candidate application, the at least one component, and the at least one data source; and perform a validation that all traces of the first candidate application, the at least one component, and the at least one data source have been removed as a result of the decommissioning.

The processor may be further configured to: after the first information has been received and before the retrieval of the second information, analyze the first information to determine whether to recommend the decommissioning of the first candidate application; and when a determination to recommend the decommissioning of the first candidate application is made, obtain an approval for the decommissioning of the first candidate application from a predetermined entity.

The processor may be further configured to validate that the at least one alternate data source is associated with the target platform, perform a data comparison between a current data state and a target data state, perform a data reconciliation based on a result of the data comparison; and confirm that the target data state is acceptable to affected entities.

The processor may be further configured to implement, during the construction of the data model, at least one data management control requirement that relates to at least one from among a data security requirement, a data access requirement, a data archiving requirement, and a data retention requirement.

The processor may be further configured to: after the construction of the data model and before the migration of the first predetermined set of data, construct a set of code that is configured to shift data consumption from the at least one data source associated with the first candidate application to the at least one alternate data source; use the data model to execute a predetermined test of the set of code; and use a result of the predetermined test to confirm that the migration of the first predetermined set of data is permissible.

The processor may be further configured to: ensure that entities impacted by the decommissioning are aware of the potential decommissioning; and document the confirmation.

The entities impacted by the decommissioning may include at least one product/application team associated with the first candidate application and at least one information owner associated with data that relates to the at least one data source.

The processor may be further configured to perform the lockdown operation by: notifying affected entities of the lockdown operation; and validating that all data objects, access points, application processes, and components are successfully locked down.

The processor may be further configured to: after the performance of the lockdown operation and before the execution of the decommissioning, execute an archival of a second predetermined set of data to a predetermined platform; apply at least one predetermined retention rule to the second predetermined set of data; and confirm that the archival of the second predetermined set of data and the application of the retention rule have been successfully completed.

According to yet another embodiment, a non-transitory computer readable storage medium storing instructions for decommissioning an application is provided. The storage medium includes a set of executable code which, when executed by a processor, causes the processor to: receive first information that relates to a first candidate application for potential decommissioning; retrieve, based on the first information, second information that relates to at least one component and at least one data source associated with the first candidate application; obtain, based on the first information, third information that relates to data usage associated with the first candidate application; identify at least one alternate data source that is associated with a target platform; construct, based on the first information, the second information, and the third information, a data model in the at least one alternate data source; migrate a first predetermined set of data associated with the first candidate application to the at least one alternate data source; obtain a confirmation for each of the potential decommissioning of the first candidate application and an archival of legacy data associated with the first candidate application; perform a lockdown operation with respect to the first candidate application, the at least one component, and the at least one data source; execute a decommissioning of the first candidate application, the at least one component, and the at least one data source; and perform a validation that all traces of the first candidate application, the at least one component, and the at least one data source have been removed as a result of the decommissioning.

When executed by the processor, the executable code may further cause the processor to: after the first information has been received and before the retrieval of the second information, analyze the first information to determine whether to recommend the decommissioning of the first candidate application; and when a determination to recommend the decommissioning of the first candidate application is made, obtain an approval for the decommissioning of the first candidate application from a predetermined entity.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates a computer system for implementing a method for decommissioning of applications, related components, and data in a consistent and complete manner in order to reduce vulnerabilities, security risks, and regulatory impacts, in accordance with an embodiment.

FIG. 2 illustrates an exemplary diagram of a network environment with a device for decommissioning of applications, related components, and data in a consistent and complete manner in order to reduce vulnerabilities, security risks, and regulatory impacts, in accordance with an embodiment.

FIG. 3 illustrates a system diagram for implementing a method for decommissioning of applications, related components, and data in a consistent and complete manner in order to reduce vulnerabilities, security risks, and regulatory impacts, in accordance with an embodiment.

FIG. 4 illustrates an exemplary flow chart of a process for decommissioning of applications, related components, and data in a consistent and complete manner in order to reduce vulnerabilities, security risks, and regulatory impacts, in accordance with an embodiment.

### DETAILED DESCRIPTION

Through one or more of its various aspects, embodiments and/or specific features or sub-components of the present disclosure, are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

As is traditional in the field of the present disclosure, example embodiments are described, and illustrated in the drawings, in terms of functional blocks, units and/or modules. Those skilled in the art will appreciate that these blocks, units and/or modules are physically implemented by electronic (or optical) circuits such as logic circuits, discrete components, microprocessors, hard-wired circuits, memory elements, wiring connections, and the like, which may be formed using semiconductor-based fabrication techniques or other manufacturing technologies. In the case of the blocks, units and/or modules being implemented by microprocessors or similar, they may be programmed using software (e.g., microcode) to perform various functions discussed herein and may optionally be driven by firmware and/or software. Alternatively, each block, unit and/or module may be implemented by dedicated hardware, or as a combination of dedicated hardware to perform some functions and a processor (e.g., one or more programmed microprocessors and associated circuitry) to perform other functions. Also, each block, unit and/or module of the example embodiments may be physically separated into two or more interacting and discrete blocks, units and/or modules without departing from the scope of the inventive concepts. Further, the blocks, units and/or modules of the example embodiments may be physically combined into more complex blocks, units and/or modules without departing from the scope of the present disclosure.

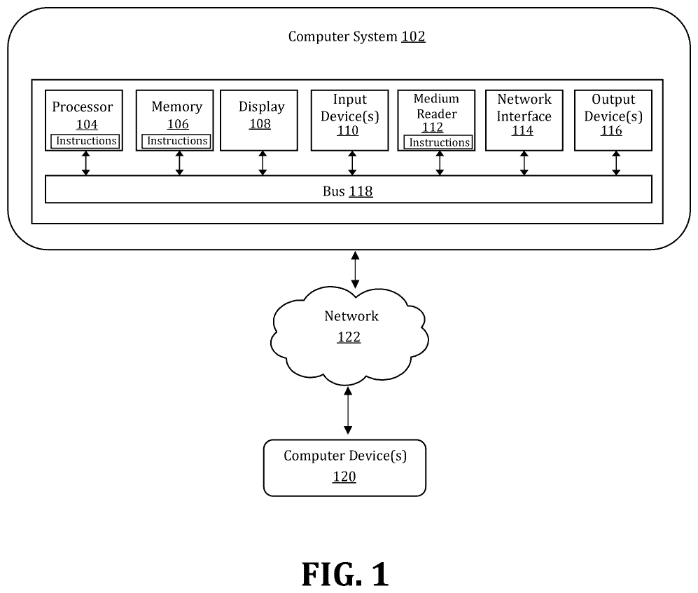

FIG. 1 is a system 100 for use in implementing a method for decommissioning of applications, related components, and data in a consistent and complete manner in order to reduce vulnerabilities, security risks, and regulatory impacts, in accordance with an embodiment. The system 100 is generally shown and may include a computer system 102, which is generally indicated.

The computer system 102 may include a set of instructions that may be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term system shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that can store data and executable instructions, and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions may be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid-state display, a cathode ray tube (CRT), a plasma display, or any other known display.

The computer system 102 may also include at least one input device 110, such as a keyboard, a touch-sensitive input screen or pad, a speech input, a mouse, a remote control device having a wireless keypad, a microphone coupled to a speech recognition engine, a camera such as a video camera or still camera, a cursor control device, a GPS device, a visual positioning system (VPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which is configured to read any one or more sets of instructions, e.g., software, from any of the memories described herein. The instructions, when executed by a processor, may be used to perform one or more of the methods and processes as described herein. In a particular embodiment, the instructions may reside completely, or at least partially, within the memory 106, the medium reader 112, and/or the processor 104 during execution by the computer system 102.

Furthermore, the computer system 102 may include any additional devices, components, parts, peripherals, hardware, software, or any combination thereof which are commonly known and understood as being included with or within a computer system, such as, but not limited to, a network interface 114 and an output device 116. The output device 116 may be, but is not limited to, a speaker, an audio out, a video out, a remote control output, a printer, or any combination thereof.

Each of the components of the computer system 102 may be interconnected and communicate via a bus 118 or other communication link. As shown in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, infrared, near field communication, ultraband, or any combination thereof. Those skilled in the art appreciate that additional networks 122 which are known and understood may additionally or alternatively be used and that the exemplary networks 122 are not limiting or exhaustive. Also, while the network 122 is shown in FIG. 1 as a wireless network, those skilled in the art appreciate that the network 122 may also be a wired network.

The additional computer device 120 is shown in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Of course, those skilled in the art appreciate that the above-listed devices are merely exemplary devices and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In some embodiments, the modules implemented by the system 100 may be platform, language, database, and cloud agnostic that may allow for consistent easy orchestration and passing of data through various components to output a desired result regardless of platform, browser, language, database, and cloud environment by writing programs accordingly. The configuration or data files, in some embodiments, may be written using JavaScript Object Notation (JSON), but the disclosure is not limited thereto. For example, the configuration or data files may easily be extended to other readable file formats such as Extensible Markup Language (XML), YAML Ain't Markup Language (YAML), etc., or any other configuration-based languages.

In accordance with various embodiments of the present disclosure, the methods described herein may be implemented using a hardware computer system that executes software programs. Further, in a non-limited embodiment, implementations can include distributed processing, component/object distributed processing, and an operation mode having parallel processing capabilities. Virtual computer system processing may be constructed to implement one or more of the methods or functionality as described herein, and a processor described herein may be used to support a virtual processing environment.

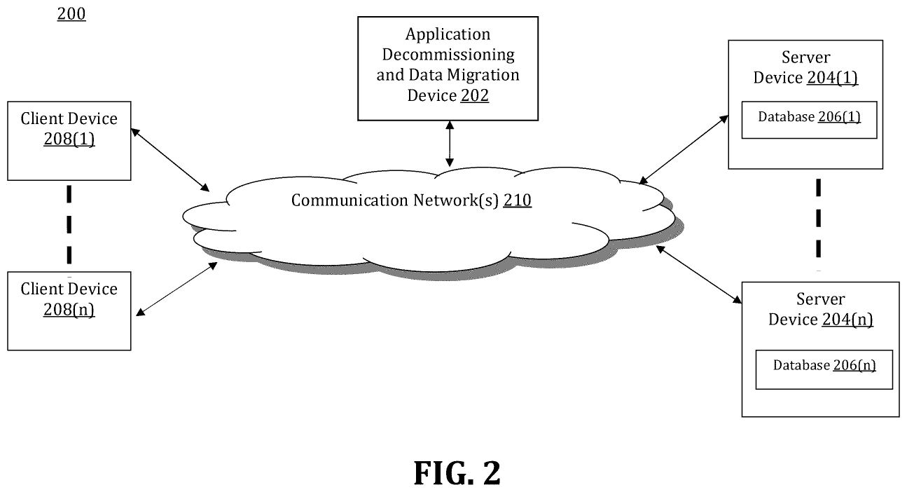

Referring to FIG. 2, a schematic of a network environment 200 for implementing an application decommissioning and data migration device (ADDMD) of the instant disclosure is illustrated.

In some embodiments, the above-described problems associated with conventional tools may be overcome by implementing a ADDMD 202 as illustrated in FIG. 2 that may be configured for implementing a method for decommissioning of applications, related components, and data in a consistent and complete manner in order to reduce vulnerabilities, security risks, and regulatory impacts, but the disclosure is not limited thereto.

The ADDMD 202 may have one or more computer system 102s, as described with respect to FIG. 1, which in aggregate provide the necessary functions.

The ADDMD 202 may store one or more applications that can include executable instructions that, when executed by the ADDMD 202, cause the ADDMD 202 to perform actions, such as to transmit, receive, or otherwise process network messages, for example, and to perform other actions described and illustrated below with reference to the figures. The application(s) may be implemented as modules or components of other applications. Further, the application(s) may be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s), and even the ADDMD 202 itself, may be located in virtual server(s) running in a cloud-based computing environment rather than being tied to one or more specific physical network computing devices. Also, the application(s) may be running in one or more virtual machines (VMs) executing on the ADDMD 202. Additionally, in one or more embodiments of this technology, virtual machine(s) running on the ADDMD 202 may be managed or supervised by a hypervisor.

In the network environment 200 of FIG. 2, the ADDMD 202 is coupled to a plurality of server devices 204(1)-204(n) that hosts a plurality of databases 206(1)-206(n), and also to a plurality of client devices 208(1)-208(n) via communication network(s) 210. A communication interface of the ADDMD 202, such as the network interface 114 of the computer system 102 of FIG. 1, operatively couples and communicates between the ADDMD 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the ADDMD 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein.

By way of example only, the communication network(s) 210 may include local area network(s) (LAN(s)) or wide area network(s) (WAN(s)), and can use TCP/IP over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like.

The ADDMD 202 may be a standalone device or integrated with one or more other devices or apparatuses, such as one or more of the server devices 204(1)-204(n), for example. In one particular example, the ADDMD 202 may be hosted by one of the server devices 204(1)-204(n), and other arrangements are also possible. Moreover, one or more of the devices of the ADDMD 202 may be in the same or a different communication network including one or more public, private, or cloud networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. The server devices 204(1)-204(n) in this example may process requests received from the ADDMD 202 via the communication network(s) 210 according to the HyperText Transfer Protocol (HTTP)-based and/or JSON protocol, for example, although other protocols may also be used.

The server devices 204(1)-204(n) may be hardware or software or may represent a system with multiple servers in a pool, which may include internal or external networks. The server devices 204(1)-204(n) hosts the databases 206(1)-206(n) that are configured to store various types of data.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a master/slave approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to peer architecture, virtual machines, or within a cloud architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. Client device in this context refers to any computing device that interfaces to communications network(s) 210 to obtain resources from one or more server devices 204(1)-204(n) or other client devices 208(1)-208(n).

In some embodiments, the client devices 208(1)-208(n) in this example may include any type of computing device that can facilitate the implementation of the ADDMD 202 that may efficiently provide a platform for implementing a method for decommissioning of applications, related components, and data in a consistent and complete manner in order to reduce vulnerabilities, security risks, and regulatory impacts, but the disclosure is not limited thereto.

The client devices 208(1)-208(n) may run interface applications, such as standard web browsers or standalone client applications, which may provide an interface to communicate with the ADDMD 202 via the communication network(s) 210 in order to communicate user requests. The client devices 208(1)-208(n) may further include, among other features, a display device, such as a display screen or touchscreen, and/or an input device, such as a keyboard, for example.

Although the exemplary network environment 200 with the ADDMD 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as may be appreciated by those skilled in the relevant art(s).

One or more of the devices depicted in the network environment 200, such as the ADDMD 202, the server devices 204(1)-204(n), or the client devices 208(1)-208(n), for example, may be configured to operate as virtual instances on the same physical machine. For example, one or more of the ADDMD 202, the server devices 204(1)-204(n), or the client devices 208(1)-208(n) may operate on the same physical device rather than as separate devices communicating through communication network(s) 210. Additionally, there may be more or fewer ADDMDs 202, server devices 204(1)-204(n), or client devices 208(1)-208(n) than illustrated in FIG. 2. In some embodiments, the ADDMD 202 may be configured to send code at run-time to remote server devices 204(1)-204(n), but the disclosure is not limited thereto.

In addition, two or more computing systems or devices may be substituted for any one of the systems or devices in any example. Accordingly, principles and advantages of distributed processing, such as redundancy and replication also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

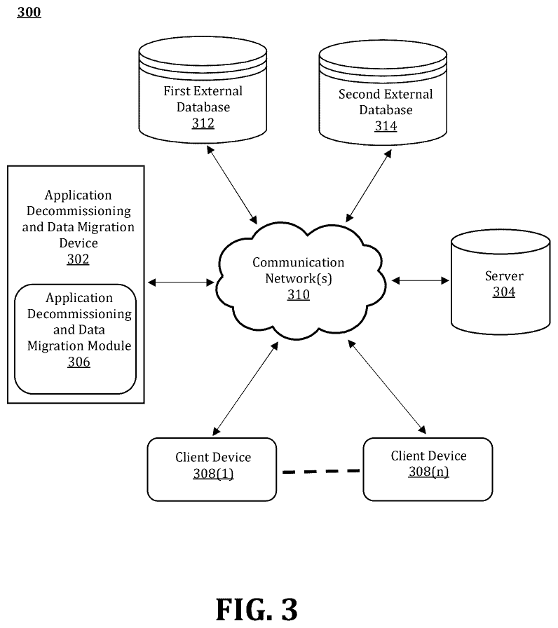

FIG. 3 illustrates a system diagram for implementing an ADDMD 302 having an application decommissioning and data migration module (ADDMM), in accordance with an embodiment.

As illustrated in FIG. 3, the system 300 may include an ADDMD 302 within which an ADDMM 306 is embedded, a server 304, a first external database 312, a second external database 314, a plurality of client devices 308(1) . . . 308(n), and a communication network 310.

In some embodiments, the ADDMD 302 including the ADDMM 306 may be connected to the server 304, and the database(s) 312 via the communication network 310. The ADDMD 302 may also be connected to the plurality of client devices 308(1) . . . 308(n) via the communication network 310, but the disclosure is not limited thereto.

In an embodiment, the ADDMD 302 is described and shown in FIG. 3 as including the ADDMM 306, although it may include other rules, policies, modules, databases, or applications, for example. In some embodiments, the first external database 312 and/or the second external database 314 may be configured to store ready to use modules written for each application programming interface (API) for all environments. Although only one database is illustrated in FIG. 3, the disclosure is not limited thereto. Any number of desired databases may be utilized for use in the disclosed invention herein. The databases 312, 314 may be a mainframe database, a log database that may produce programming for searching, monitoring, and analyzing machine-generated data via a web interface, etc., but the disclosure is not limited thereto.

In some embodiments, the ADDMM 306 may be configured to receive real-time feed of data from the plurality of client devices 308(1) . . . 308(n) and secondary sources via the communication network 310.

As may be described below, the ADDMM 306 may be configured to: receive first information that relates to a first candidate application for potential decommissioning; retrieve second information that relates to at least one component and at least one data source associated with the first candidate application; obtain third information that relates to data usage associated with the first candidate application; identify at least one alternate data source that is associated with a target platform; construct a physical data model in the at least one alternate data source; migrate a predetermined set of data associated with the first candidate application to the at least one alternate data source; obtain a confirmation for a decommissioning of the first candidate application and for an archival of legacy data associated with the first candidate application; perform a lockdown operation with respect to the first candidate application, the at least one component, and the at least one data source; execute a physical decommissioning of the first candidate application, the at least one component, and the at least one data source; and perform a validation that all traces of the first candidate application, the at least one component, and the at least one data source have been removed as a result of the physical decommissioning, but the disclosure is not limited thereto.

The plurality of client devices 308(1) . . . 308(n) are illustrated as being in communication with the ADDMD 302. In this regard, the plurality of client devices 308(1) . . . 308(n) may be “clients” (e.g., customers) of the ADDMD 302 and are described herein as such. Nevertheless, it is to be known and understood that the plurality of client devices 308(1) . . . 308(n) need not necessarily be “clients” of the ADDMD 302, or any entity described in association therewith herein. Any additional or alternative relationship may exist between either or both of the plurality of client devices 308(1) . . . 308(n) and the ADDMD 302, or no relationship may exist.

The first client device 308(1) may be, for example, a smart phone. Of course, the first client device 308(1) may be any additional device described herein. The second client device 308(n) may be, for example, a personal computer (PC). Of course, the second client device 308(n) may also be any additional device described herein. In some embodiments, the server 304 may be the same or equivalent to the server device 204 as illustrated in FIG. 2.

The process may be executed via the communication network 310, which may comprise plural networks as described above. For example, in an embodiment, one or more of the plurality of client devices 308(1) . . . 308(n) may communicate with the ADDMD 302 via broadband or cellular communication. Of course, these embodiments are merely exemplary and are not limiting or exhaustive.

The computing device 301 may be the same or similar to any one of the client devices 208(1)-208(n) as described with respect to FIG. 2, including any features or combination of features described with respect thereto. The ADDMD 302 may be the same or similar to the ADDMD 202 as described with respect to FIG. 2, including any features or combination of features described with respect thereto.

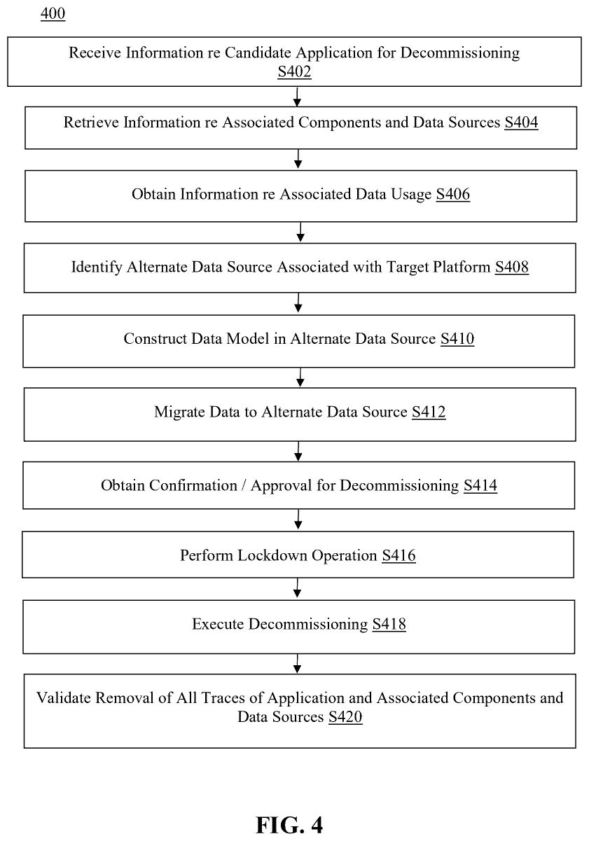

FIG. 4 illustrates an exemplary flow chart of a process 400 implemented by the ADDMM 306 of FIG. 3 for enablement of a system and a method for decommissioning of applications, related components, and data in a consistent and complete manner in order to reduce vulnerabilities, security risks, and regulatory impacts, in accordance with an embodiment. It may be appreciated that the illustrated process 400 and associated steps may be performed in a different order, with illustrated steps omitted, with additional steps added, or with a combination of reordered, combined, omitted, or additional steps.

As illustrated in FIG. 4, at step S402, the process 400 may include receiving first information that relates to a candidate application (also referred to herein as a “legacy application”) for a potential decommissioning operation. In an embodiment, the first information may include an identification of the candidate application and information that relates to product/application team management personnel that may be impacted by the potential decommissioning. The first information may also include required confirmations and/or approvals to proceed with the process 400. In an embodiment, artifacts associated with the required confirmations and/or approvals may be documented.

In an embodiment, a high level analysis may be performed with respect to entities that may be impacted by the potential decommissioning, such as architecture groups, product groups, application groups, and consumer groups. Architecture diagrams that are relevant and available may be collected and documented. An evolution of the candidate application may also be documented. Based on a result of the high level analysis, a listing of an end-to-end process and data flow steps may be documented. Internal and external touchpoints may be noted, and the documentation may be translated to one or more flow diagrams.

In an embodiment, the first information may be analyzed to determine whether to recommend the decommissioning of the legacy application. When a determination is made to recommend the decommissioning, an approval for the decommissioning may be obtained from a predetermined entity, such as, for example, a person that has authorization to decide whether to proceed with the decommissioning.

At step S404, the process 400 may include retrieving second information that relates to components and data sources that are associated with the candidate application that is associated with the first information. In an embodiment, the second information may include a listing of components, such as code, scripts, jobs, and schedulers; and an identification of all data sources that are used and/or accessed by the candidate application. In this aspect, the second information may be used to create and document an inventory of all components and data sources associated with the candidate application. The inventory may then be used to generate a dependency matrix that lists all touchpoints and interfaces; identifies all dependencies, for example, as between upstream versus downstream, or as between publish versus consume; and illustrates dependencies among applications, technology, tools, access, boundaries, and all other relevant dependencies. In an embodiment, the dependency matrix may also be included in the second information.

At step S406, the process 400 may include obtaining third information that relates to data usage associated with the candidate application associated with the first information. In an embodiment, the third information may include a listing of all data sources that are used. The third information may further include a documentation of interface modes that correspond to the listed data sources. Data usage information may be collected, a consumption analysis may be performed, and the third information may further include the results thereof. The third information may also include an identification of all data objects and entities that are touched or otherwise affected.

In an embodiment, the third information may further include usage information that may be collected at a relatively lower grain-attribute level. A data lineage analysis may be conducted, and data lineage mappings may be collected and collated. Results of these operations may be consolidated and documented in order to generate documentation that relates to data sources, data object usage, data attribute usage, and data lineage. The documentation may then be validated with all relevant consumer groups. Confirmations from such groups may be obtained and documented. In an embodiment, each of the results of the data lineage analysis, the data lineage mappings, the associated documentation, and the confirmations may be further included in the third information.

At step S408, the process 400 may include identifying at least one alternate data source that is associated with a target platform to be used for hosting a successor to the candidate application, such as, for example, an updated version of the candidate application or a new application that is designed to replace the candidate application. In an embodiment, the identification of alternate data sources entails a review of consumption requirements, including engagement with relevant product and application groups and reviewing and documenting business usage and consumption patterns and requirements; and confirming an architecture/design authority direction on a target state, including conducting reviews with architecture and design authority groups. The identification may also entail identifying data objects and attributes, and validating that the identified alternate data sources are associated with a target platform that is usable for hosting the successor to the candidate application. In an embodiment, the identification of alternate data sources may also include a performance of a data comparison between a current data state and a target data state, a performance of a data reconciliation based on a result of the data comparison, and a confirmation that the target data state is acceptable to affected entities, such as, for example, relevant consumer groups.

At step S410, the process 400 may include constructing a data model in one or more of the alternate data sources identified in step S408. In an embodiment, the construction of the data model is based on the first information received in step S402, the second information retrieved in step S404, and the third information obtained in step S406. In an embodiment, the modeling may include modeling data, data objects, and data attributes; validating and confirming that all relevant data management and governance standards are satisfied; and implementing data management control requirements, such as data security control requirements, data access control requirements, data archiving control requirements, and data retention control requirements. In an embodiment, a detailed data content and consumption analysis that had previously been done with respect to the candidate application leads to creation of a new, efficient, and performant data model in the alternate data sources, and is designed to provide similar or better data quality for consumers. In an embodiment, the data management control requirements that had previously existed with respect to the candidate application may be automatically extracted and provided for an initial review and potential modification by data owners and/or risk stewards, and upon receiving a certification therefrom, an automatic implementation of the data management control requirements may be performed.

In an embodiment, after the data model has been constructed, new code that is designed to pivot/shift data consumption from the legacy data sources to the alternate data sources may be built. The new code may be tested by using the data model to execute a rigorous test and then conducting a data comparison and reconciliation. In an embodiment, this includes testing, comparing, and reconciling the data contained and provisioned from the newly constructed data model to that of the data from the candidate application through the use of one or more trained machine learning models and analytics, in order to ensure quality data and no loss of critical data elements. When a result of the testing is acceptable, then a confirmation that a migration of a predetermined set of data to the alternate data sources is permissible may be obtained. In an embodiment, the predetermined set of data includes all data that is associated with the candidate application for which there is an intention to retain and/or maintain such data after the candidate application has been decommissioned.

At step S412, the process 400 may include migrating the predetermined set of data to the alternate data sources. In an embodiment, the migration may entail performing a transfer from the legacy application to the new code and/or to an updated set of code consuming from the alternate data sources. Post-transfer go-live warranty support may then be provided.

At step S414, the process 400 may include obtaining confirmation and/or approval to proceed with the decommissioning of the legacy application. In an embodiment, this step may entail confirming that the post-migration consumption is fully business-as-usual (BAU) from the alternate data sources; completing the post-transfer go-live warranty support period; and engaging with entities impacted by the decommissioning, such as, for example, product/application teams associated with the legacy application and/or information owners associated with data associated with the legacy application, to ensure that such entities are aware of the imminent decommissioning, and also to ensure that applicable data archival and retention requirements are satisfied. When confirmation and/or approval are obtained, documentation thereof may be made. In an embodiment, step S414 may be performed automatically by ADDMM 306 by execution of program code.

At step S416, the process 400 may include performing a lockdown operation with respect to the legacy application and the components and data sources associated with the legacy application. In an embodiment, the lockdown operation refers to an operation that disables the legacy application so that it can no longer be executed, and so that the components and data sources associated with the legacy application are also disabled with respect to interactions with the legacy application. In an embodiment, the lockdown operation may entail defining and finalizing a scope of the lockdown with respect to application components, processes, data objects, and access points; communicating with affected entities to notify them of the impending lockdown operation; and then disabling the legacy application and all interactions with components and data sources associated therewith. At the end of the lockdown operation, a validation that all data objects, access points, legacy application processes, and components are successfully locked down may be obtained. In the event that there are issues regarding the successful completion of the lockdown operation, a review, reevaluation, and reexecution of relevant aspects of the lockdown operation may be performed.

In an embodiment, after the lockdown operation has been completed, a data archival operation may be performed. The archival operation may entail identifying which data is to be archived and/or retained; identifying a platform to which the archival is to be performed, and then obtaining a confirmation regarding the identified platform; reviewing and finalizing data archival requirements; listing and confirming all data objects to be archived; and obtaining and documenting approvals from affected entities, including product/application teams, information owners, and relevant governance groups. When all necessary approvals have been received, the data archival may be executed, and applicable retention rules may be applied. In an embodiment, a validation operation may be performed to confirm that the archival operation and the retention rule application have been successfully completed.

At step S418, the process 400 may include executing a decommissioning of the legacy application. In an embodiment, this step may entail finalizing a scope of the decommission with respect to components, processes, data objects, and access points; planning and communicating with affected entities; executing the decommissioning operation; and validating a successful completion of the decommissioning. In the event that there are issues regarding the successful completion of the decommissioning, a review, reevaluation, and reexecution of relevant aspects of the decommissioning operation may be performed.

At step S420, the process 400 may include validating a removal of all traces of the legacy application and the associated components and data sources. In an embodiment, the validation entails confirming that no legacy application-related footprint exists and documenting the confirmation. In an embodiment, the confirmation that no legacy application-related footprint exists may be obtained by searching the platform that was used to host the legacy application and checking the result of the search to determine whether any remnants of the legacy application remain present on the platform. In this aspect, when the result of the search indicates that remnants of the legacy application remain present, the remnants may be removed or deleted; and when the result of the search indicates that there are no remaining remnants of the legacy application, then the confirmation may be provided. Steps and/or workflows to update application—asset associations and mappings may be initiated, and updates to metadata libraries associated with relevant applications, assets, and architectures may also be performed. Finally, a certification that the decommissioning is completed with no trace left behind may be provided. In an embodiment, step S420 may be performed automatically by ADDMM 306 by execution of program code.

In some embodiments as disclosed above in FIGS. 1-4, technical improvements effected by the instant disclosure may include a platform for implementing an application decommissioning and data migration module configured for enablement of decommissioning of applications, related components, and data in a consistent and complete manner in order to reduce vulnerabilities, security risks, and regulatory impacts, but the disclosure is not limited thereto.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium may be a random access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, may be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, may be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A method for decommissioning an application, the method being implemented by at least one processor, the method comprising:
receiving first information that relates to a first candidate application for a potential decommissioning;
retrieving, based on the first information, second information that relates to at least one component and at least one data source associated with the first candidate application;
obtaining, based on the first information, third information that relates to data usage associated with the first candidate application;
identifying at least one alternate data source that is associated with a target platform to be used for hosting a successor to the first candidate application;
constructing, based on the first information, the second information, and the third information, a data model in the at least one alternate data source;
migrating a first predetermined set of data associated with the first candidate application to the at least one alternate data source;
obtaining a confirmation for each of the potential decommissioning of the first candidate application and an archival of legacy data associated with the first candidate application;
performing a lockdown operation with respect to the first candidate application, the at least one component, and the at least one data source;
executing a decommissioning of the first candidate application, the at least one component, and the at least one data source; and
performing a validation that all traces of the first candidate application, the at least one component, and the at least one data source have been removed as a result of the decommissioning.

2. The method of claim 1, further comprising:
after the receiving of the first information and before the retrieving of the second information, analyzing the first information to determine whether to recommend the decommissioning of the first candidate application; and
when a determination to recommend the decommissioning of the first candidate application is made, obtaining an approval for the decommissioning of the first candidate application from a predetermined entity.

3. The method of claim 1, wherein the identifying of the at least one alternate data source comprises validating that the at least one alternate data source is associated with the target platform, performing a data comparison between a current data state and a target data state, performing a data reconciliation based on a result of the data comparison; and confirming that the target data state is acceptable to affected entities.

4. The method of claim 1, wherein the constructing of the data model comprises implementing at least one data management control requirement that relates to at least one from among a data security requirement, a data access requirement, a data archiving requirement, and a data retention requirement.

5. The method of claim 4, further comprising:
after the constructing of the data model and before the migrating of the first predetermined set of data, constructing a set of code that is configured to shift data consumption from the at least one data source associated with the first candidate application to the at least one alternate data source;
using the data model to execute a predetermined test of the set of code; and
using a result of the predetermined test to confirm that the migrating of the first predetermined set of data is permissible.

6. The method of claim 1, wherein the obtaining of the confirmation for each of the potential decommissioning of the first candidate application and the archival of the legacy data comprises:
ensuring that entities impacted by the decommissioning are aware of the potential decommissioning; and
documenting the confirmation.

7. The method of claim 6, wherein the entities impacted by the decommissioning include at least one product/application team associated with the first candidate application and at least one information owner associated with data that relates to the at least one data source.

8. The method of claim 1, wherein the performing of the lockdown operation comprises:
notifying affected entities of the lockdown operation; and
validating that all data objects, access points, application processes, and components are successfully locked down.

9. The method of claim 1, further comprising:
after the performing of the lockdown operation and before the executing of the decommissioning, executing an archival of a second predetermined set of data to a predetermined platform;
applying at least one predetermined retention rule to the second predetermined set of data; and
confirming that the archival of the second predetermined set of data and the applying of the retention rule have been successfully completed.

10. A computing apparatus for decommissioning an application, the computing apparatus comprising:
a processor;
a memory; and
a communication interface coupled to each of the processor and the memory,
wherein the processor is configured to:
receive, via the communication interface, first information that relates to a first candidate application for potential decommissioning;
retrieve, from the memory based on the first information, second information that relates to at least one component and at least one data source associated with the first candidate application;
obtain, based on the first information, third information that relates to data usage associated with the first candidate application;
identify at least one alternate data source that is associated with a target platform to be used for hosting a successor to the first candidate application;
construct, based on the first information, the second information, and the third information, a data model in the at least one alternate data source;
migrate a first predetermined set of data associated with the first candidate application to the at least one alternate data source;
obtain a confirmation for each of the potential decommissioning of the first candidate application and an archival of legacy data associated with the first candidate application;
perform a lockdown operation with respect to the first candidate application, the at least one component, and the at least one data source;
execute a decommissioning of the first candidate application, the at least one component, and the at least one data source; and
perform a validation that all traces of the first candidate application, the at least one component, and the at least one data source have been removed as a result of the decommissioning.

11. The computing apparatus of claim 10, wherein the processor is further configured to:
after the first information has been received and before the retrieval of the second information, analyze the first information to determine whether to recommend the decommissioning of the first candidate application; and
when a determination to recommend the decommissioning of the first candidate application is made, obtain an approval for the decommissioning of the first candidate application from a predetermined entity.

12. The computing apparatus of claim 10, wherein the processor is further configured to validate that the at least one alternate data source is associated with the target platform, perform a data comparison between a current data state and a target data state, perform a data reconciliation based on a result of the data comparison; and confirm that the target data state is acceptable to affected entities.

13. The computing apparatus of claim 10, wherein the processor is further configured to implement, during the construction of the data model, at least one data management control requirement that relates to at least one from among a data security requirement, a data access requirement, a data archiving requirement, and a data retention requirement.

14. The computing apparatus of claim 13, wherein the processor is further configured to:
after the construction of the data model and before the migration of the first predetermined set of data, construct a set of code that is configured to shift data consumption from the at least one data source associated with the first candidate application to the at least one alternate data source;
use the data model to execute a predetermined test of the set of code; and
use a result of the predetermined test to confirm that the migration of the first predetermined set of data is permissible.

15. The computing apparatus of claim 10, wherein the processor is further configured to:
ensure that entities impacted by the decommissioning are aware of the potential decommissioning; and
document the confirmation of the decommissioning.

16. The computing apparatus of claim 15, wherein the entities impacted by the decommissioning include at least one product/application team associated with the first candidate application and at least one information owner associated with data that relates to the at least one data source.

17. The computing apparatus of claim 10, wherein the processor is further configured to perform the lockdown operation by:
notifying affected entities of the lockdown operation; and
validating that all data objects, access points, application processes, and components are successfully locked down.

18. The computing apparatus of claim 10, wherein the processor is further configured to:
after the performance of the lockdown operation and before the execution of the decommissioning, execute an archival of a second predetermined set of data to a predetermined platform;
apply at least one predetermined retention rule to the second predetermined set of data; and
confirm that the archival of the second predetermined set of data and the application of the retention rule have been successfully completed.

19. A non-transitory computer readable storage medium storing instructions for decommissioning an application, the storage medium comprising executable code which, when executed by a processor, causes the processor to:
receive first information that relates to a first candidate application for potential decommissioning;
retrieve, based on the first information, second information that relates to at least one component and at least one data source associated with the first candidate application;
obtain, based on the first information, third information that relates to data usage associated with the first candidate application;
identify at least one alternate data source that is associated with a target platform to be used for hosting a successor to the first candidate application;
construct, based on the first information, the second information, and the third information, a data model in the at least one alternate data source;
migrate a first predetermined set of data associated with the first candidate application to the at least one alternate data source;
obtain a confirmation for each of the potential decommissioning of the first candidate application and an archival of legacy data associated with the first candidate application;
perform a lockdown operation with respect to the first candidate application, the at least one component, and the at least one data source;
execute a decommissioning of the first candidate application, the at least one component, and the at least one data source; and
perform a validation that all traces of the first candidate application, the at least one component, and the at least one data source have been removed as a result of the decommissioning.

20. The storage medium of claim 19, wherein when executed by the processor, the executable code further causes the processor to:
after the first information has been received and before the retrieval of the second information, analyze the first information to determine whether to recommend the decommissioning of the first candidate application; and
when a determination to recommend the decommissioning of the first candidate application is made, obtain an approval for the decommissioning of the first candidate application from a predetermined entity.
